(19) United States
(12) Patent Application Publication
(10) Pub. No.: US 2009/0055466 A1
(43) Pub. Date: Feb. 26, 2009

(54) GRID-BASED SYSTEM FOR PROVIDING BUSINESS SERVICES IN DATA NETWORKS

(75) Inventors: Adi Hadas, Holon (IL); Ronen Hamias, Holon (IL); Asaf Lahav, Kfar Sava (IL)

Correspondence Address: MERCHANT & GOULD PC, P.O. BOX 2903, MINNEAPOLIS, MN, 55402-0903, US

(73) Assignee: Prima Grid LTD., Tel Aviv (IL)

(21) Appl. No.: 11/844,062

(22) Filed: Aug. 23, 2007

(51) Int. Cl. G06F 15/173

(52) U.S. Cl. 709/202

(57) ABSTRACT

A system for exposing and extending existing IT capabilities as standard business services, while providing infrastructure services to an organization over a data network, has a group of configured agents. Each agent runs services that represent a certain entity on the organization's network and is responsible for controlling the functionality of the represented IT resource on the organization's network, while being a runtime engine for services that represent IT resources of the organization and a Peer-to-Peer topology layer for connecting between the agents, while exploiting the existing physical data channels of the data network.

### FIELD OF THE INVENTION

The present invention relates to the field of Service Oriented Architecture (SOA) services. Specifically, this invention relates to highly flexible and decentralized grid-based services system.

### BACKGROUND OF THE INVENTION

Many enterprises, whether large or small, incorporate internal data networks, such as LANs and WANs. Typically, organizations and enterprises several of sub-units or divisions, each of which comprises different types of data in different formats and may have its own sub-network and computer functions. These sub-networks and computer functions of the sub-units are all connected to the general data network of the organization.

Various problems arise in organizations due to the inconsistency of the computer functions of the different sub-units or divisions. Often, each sub-unit purchases various computational platforms from different vendors, and there is no guarantee that the different types of computational platforms will be able to exchange data, or even to communicate with each other. All of the sub-units of the organization may not even use the same operating system, which is a limitation that complicates things even further. In addition, all the sub-units of the organization may share common centralized services, such as security, access authorizations, data storage, backup, etc. Such services are often known as “Infrastructure Services”.

Since sharing business data is extremely important for organizations to be able to operate efficiently, there have been various attempts to solve the problem presented hereinabove.

The first dominant integration architecture that emerged from the cumbersome point-to-point application integration model was the “Hub-and-spoke” architecture, often referred to as “message broker.” Hub-and-spoke architectures consist of a centralized hub that receives requests from multiple applications that are connected to the centralized hub as spokes.

One major drawback of this solution is that the centralized hub presents a single point of failure in the overall architecture. Another drawback is that most hub-and-spoke-based Enterprise Application Integration (EAI, which is a program that coordinates the computer applications in an enterprise) software products are monolithic, expensive systems, based on proprietary standards.

With the emergence of Service Oriented Architecture (SOA), the Enterprise Service Bus (ESB) was introduced. An ESB is architecture based on Web services standards, which delivers a middleware infrastructure (middleware programs provide mediation services so that different applications can communicate). An ESB provides the same functionality as a “traditional” broker in a Hub-and-spoke architecture. Furthermore, the ESB architecture is very similar to the Hub-and-spoke architecture, as they both feature the concept of a central entity that integrates the other IT resources.

Several problems may arise from implementing the ESB architecture and its concept of a central entity that integrates mission critical applications: The bus features a single point-of-failure, bottlenecks may arise as more and more services are deployed onto the bus, low scalability as instancing the bus is not a simple task, and low redundancy. Furthermore, the need for governance, security, and rich services infrastructure is not met using the Broker and ESB-based solutions.

It would therefore be highly desirable to develop a services system for Information Technology (IT) systems of sub-units of an organization, which is flexible, decentralized, and cost effective.

It is an object of the present invention to provide a services system for communicating and exchanging data between different IT systems through business services consumption in sub-units of an organization, which is optimally decentralized.

It is another object of the present invention to provide a services system for IT systems in sub-units of an organization that is comprehensive and independent of a sub-unit's system architecture.

It is a further object of the present invention to provide a services system for IT systems in sub-units of an organization that is comprehensive and independent of a sub-unit's system architecture, specific data transfer protocols and/or operating systems.

Further purposes and advantages of this invention will become apparent as the description proceeds.

### SUMMARY OF THE INVENTION

The present invention is directed to a system for exposing and extending existing IT capabilities as standard business services, while providing infrastructure services to an organization over a data network, that comprises:
a) a group of agents, each of which is a runtime engine for services that represent IT resources of the organization; and
b) a Peer-to-Peer topology layer for connecting between the agents, while exploiting the existing physical data channels of the data network.

The group of agents may consist of configured agents, such each agent may run services that represent a certain entity on the organization's network and is responsible for controlling the functionality of the represented IT resource on the organization's network. Alternatively, the group of agents may consist of configured agents, such that each agent may run services that are responsible to provide infrastructure services for the whole network. The group of agents may also consist of configured agents, wherein each agent may run services that are responsible to offer independent business logic. The configuration of the agents may be performed through a management console, such as a User Interface program that is able to configure the agents and publish the configured metadata to the appropriate agents, for modifying them.

The group of agents may comprise:

a network layer that comprises the connection of the agent to the organization's network;
a logical layer comprises configured business services, and means for monitoring, analysis, security, enterprise policy enforcement, and execution of the business services; and
a data access layer that comprises the connection between the agent and the entity which it may represent on the organization's network.

The agents may host business services, which consist of Business Events, Business Operations, and Business Properties.

Preferably, the agents expose the business services as standard grid services that may be instanced, offer parallel computation, and allow compensation when a grid service is shutdown. The agents may be configured by a configuration process to:
fit the agents to the organization's communication protocol;
define the hosted business services of the agents; and
fit the agents to the entity on the organization's network, which their hosted business services may represent.

The agents may be reconfigured at any time, to change their designated operations. In addition, one or more agents can connect to external IT resources. Several IT resources in the organization may be unconnected to the system.

All the above and other characteristics and advantages of the invention will be further understood through the following illustrative and non-limitative description of preferred embodiments thereof.

### BRIEF DESCRIPTION OF DRAWINGS

The above and other characteristics and advantages of the invention will be better understood through the following illustrative and non-limitative detailed description of preferred embodiments thereof, with reference to the appended drawings, wherein:

FIG. 1 schematically shows the two agents, connected to two different IT systems and to the organization's network, and one infrastructure agent connected only to the organization's network;

FIGS. 2a and 2b schematically show the connectivity between the different agents through the organization's network;

FIG. 3 schematically illustrates a typical ESG architecture, according to a preferred embodiment of the present invention; and

FIG. 4 schematically illustrates the layers of each agent in a conceptual level, according to a preferred embodiment of the invention.

### DETAILED DESCRIPTION OF PREFERRED EMBODIMENTS

In light of the disadvantages of the interfaces, brokers and ESBs, as described hereinabove, there is a need for advanced integration architecture, for use in organizations consisting of sub-units that employ different IT systems.

The present invention discloses a system for providing improved business services in organizations, which implements innovative integration architecture, called herein below the Enterprise Service Grid (ESG).

The ESG allows to implement an integration backbone which integrates, manages, and coordinates the enterprise IT resources and applications in a non-centralized, highly distributed grid environment.

The ESG integrates and coordinates IT resources (software, applications, hardware, devices) and addresses the integration issues such as security, policy, and others.

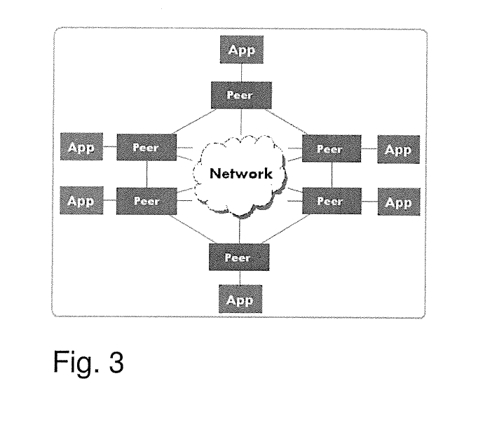

The resources' capabilities are exposed as reusable standard services, through the peers in the ESG. Communication and discovery of peers is not subject to any centralized control. A typical ESG architecture is demonstrated in FIG. 3.

Each peer holds the capabilities needed to communicate with one or more resources, and seamlessly communicate with all other peers.

Resources are connected to the ESG through the peers, which are—smart agents that encapsulate system functionality and provide a layer of abstraction between the ESG and the resources. All smart agents utilize open communication standards, and implement typical integration capabilities, such as data transformation, policy enforcement, security, and such.

The ESG architecture has no centralized entity, which provides integration functionality, but rather a collection of peers, which represents various capabilities. These include middleware services, which provide needed integration capabilities.

ESG utilizes peer-to-peer foundation to provide on demand point-to-point interfaces between resources. The ESG is highly non-intrusive, as current systems are unchanged while the integration level is completely separated from the applications.

ESG provides vertical (relating to different levels in a hierarchy), standard-based management abilities, including security, policy, reliability, logging, management, etc.

The system proposed by the present invention is a services software system that functions as a platform that provides information integration and central management for organizational IT resources. It implements the described ESG architecture, and features a peer-to-peer network of smart agents, which host and expose grid services. The Enterprise Application Integration is performed through the agents, which represent the applications in the network.

Agents, as known to those familiar with the software art, are computer programs that gather information or perform some other service without the need for user's interference. The configuration of the agents is being done through a management console, which is a User Interface program that is able to configure the agents, and publish the configured metadata to the appropriate agents, in order to modify them.

The data network of the organization, according to the present invention, is configured, such that each entity is (or can be) represented by a certain agent.

The connectivity between the agents in the data network of the present invention creates a peer-to-peer topology, so that any agent can directly communicate with all other agents over the existing physical data channels of network. Such multi-connectivity between the different agents enables the network of the organization to work in a more efficient manner. The agents are not only capable of communicating with each other, they can also gather data concerning other IT resources on the network of the organization through the other agents, and can respond whenever desired, in order to optimize the infrastructure services of the network even further. In addition, the multi-connectivity of the agents, according to the present invention, enables any user with the correct authorization (e.g., the system administrator) to observe information related to the status of any service or resource in the organization from his own workstation.

Unlike commonly used specific interfaces, the agent-based system proposed by the present invention is highly flexible and allows many different tasks to be optimized. Many tedious tasks, such as load balancing and backup can be performed easily by implementing the infrastructure services proposed by the present invention.

The agents of the present invention can also provide load balancing. If, for example, two users happen to send printing jobs to the same printer, the agent connected to that printer can be configured to enforce enterprise policy, such as to ask the second user whether he would like to send that printing job to another printer. In another embodiment of the present invention, the relevant agent can automatically redirect the printing job to a different printer, when necessary

The agent-based system of the present invention can also optimize the policy enforcement of an organization. Any set of rules the organization wishes to enforce, can be configured into the relevant agents, and by their control over the data transfer on the network of the organization, they can enforce those rules. For example, an organization can decide that no black and white documents should be printed using a color printer. A designated agent can monitor all files being sent to the color printers, while checking whether any of those files is defined as a black and white file. Once such a file is detected, the designated agent either automatically refers that file to be printed on another printer, or notifies the user that the file he wishes to print must be printed on a black and white printer, and asks him to redirect the printing job accordingly.

The agent-based integration system of the present invention can also offer services that the resources themselves do not offer. For example, specific business logic, programmed into the relevant agents, can determine which types of files should be sent to which printers and how they should be printed. An example for such a set of rules is as follows:
1. Only files containing color may be printed on a colored printer.
2. Files containing only text should be printed only on laser printers.
3. Files containing more than 50 pages should be printed on both sides of the page (what is known as “duplex” printing).

The user then does not need to specify which printer a file should be printed on, and further, he does not need to specify the properties of that printer for each printing job. This eases both the organization's policy enforcement and the user's exploitation of the computer resources and services connected to the organization's network.

Agents can also be implemented according to the present invention for automating processes, as a designated agent can automatically execute complex processes when a specific invocation has been made or when a business event was detected. For example, when inserting the details of a new employee to the salaries system, the agent may distribute the data inserted to all relevant systems, such as the Human-Resources system, etc.

In order for each generic agent implemented according to the present invention to be able to follow its designated tasks, the each agent must go through what is known in the art as a configuration process (CP). The CP of each agent fits that agent to the IT resource (IT system, self-made application, printer, etc.), which it represents on the network of the organization. During the CP, the protocol of the specific IT resource is also considered, so that the agents will operate on the same existing communication protocol of the network (e.g., the agents and the network data channels will all work according to the TCP/IP protocol). Once configured properly, the agents can be used disregarding the type of operating systems and communication protocol used by the organization's data network.

As would be understood by those familiar with the art, the agents themselves are extremely versatile, so that different CPs can configure a certain agent, enabling it to operate in different designated manners. In addition, the agents are dynamic, i.e., if it is necessary to change the operation of any agent on the network, that agent can be simply updated by an update CP.

One of the main advantages of the agent-based integration system of the present invention is that the agents, which are software modules, can be added onto any network while creating a grid topology, no matter what is the physical topology of that network. Furthermore, implementing the integration system of the present invention does not require any changes in the organization's physical network. The agents, connected in a point-to-point topology to create a grid of agents, create a logical, rather than physical, network on top of the existing physical network. The connectivity of the created logical network is much higher than the physical network, thereby optimizing the operations of the organization's network. In addition, since the physical network is not changed, the organization can have certain services and/or resources remain working as before, without being influenced in any manner by the operation of agents.

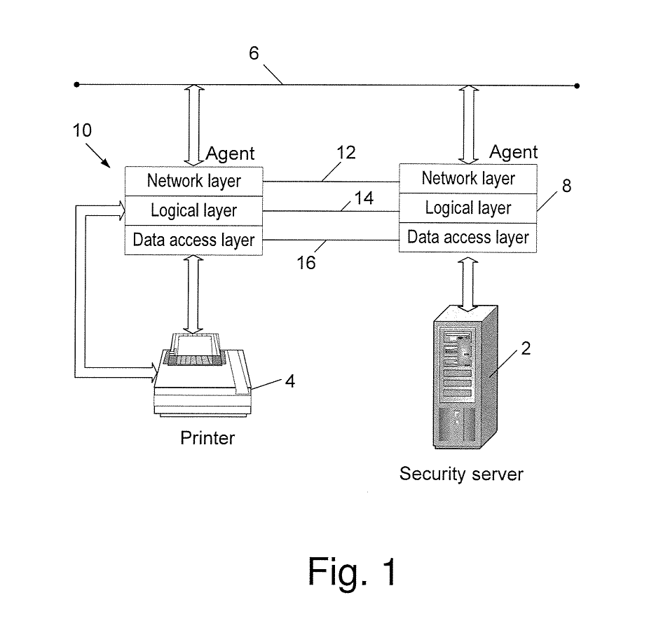

Referring to FIG. 1, it can be seen that each entity, for example, a security server (2) and a printer (4), are connected together through the organization's network (6) via predefined agents (8) and (10), respectively. Each agent can be described as comprising three layers: the network layer (12), the logical layer (14), and the data access layer (16).

Network layer (12) is connected to the organization's data network and through it, all the data is exchanged with agents of other IT resources over the organization's network. The network layer enables the agent entities to perform bi-directional communication over the network.

Logical layer (14) features the Service Runtime Engine. The Service Runtime engine implements a flexible business logic runtime mechanism, which is the “core” of the agent. The Service Runtime engine dynamically realizes “business services”, which are logical-grouping of user-defined capabilities, by sequencing actions. These actions converted into Business Operations, Business Properties and Business Events, which comprise the business service, and are exposed to other agents across the enterprise by the agent.

Data access layer (16) features the adapter framework, which enables the agent to communicate with the resource it represents in the network, enables to plug any custom and protocol-specific adapter to it.

Agent (10) connected to printer (4) can, for example, monitor the ink or toner of printer (4) in addition to the number of pages in that printer. If any of the above runs low, agent (10) can notify the system administrator of its state. Agent (10) can also alert the system administrator in case there are any malfunctions related to printer (4).

In addition, agent (10) can be programmed to provide load balancing of executing printing jobs. If a user sends a printing job to printer (4) when that printer is occupied, the agent can be programmed to notify the user that printer (4) will be occupied for a certain amount of time, and it may ask the user whether he would like the printing job to be sent to a different printer. According to another embodiment of the present invention, agent (10) may be programmed to automatically refer the printing job to a different, equivalent, printer, notifying the user of the location of his printout.

Two types of business services may run on the Agent's engine:

1. Business Services that are mapped to one or more IT resources and expose those IT resources' capabilities.
2. Business Services that represent the infrastructure capabilities required by the network, such as monitoring, auditing, security, policy enforcement, etc.

“Resource agents” are agents, which run the first type of business services.

“Infrastructure agents” are agents, which run the seconds type of business services, and are responsible to offer general common services to all the IT resources connected to the grid. Therefore, their business logic is configured to offer the appropriate business services to the entire grid. For example, a monitoring agent can receive data form several resource agents concerning ink/toner and paper levels on all printers, in addition to any information regarding malfunctions of those printers. If the monitoring agent receives data from any resource agent informing that a certain printer in the organization is low either on ink/toner or on paper, or that there is some type of malfunction on that printer, it will notify the system administrator, based on pre-configured policy.

While resource agents must be configured according to the organization's network communication protocol, as well as according to the service/resource that they represent, the infrastructure agents are configured only in respect to the organization's network communication protocol.

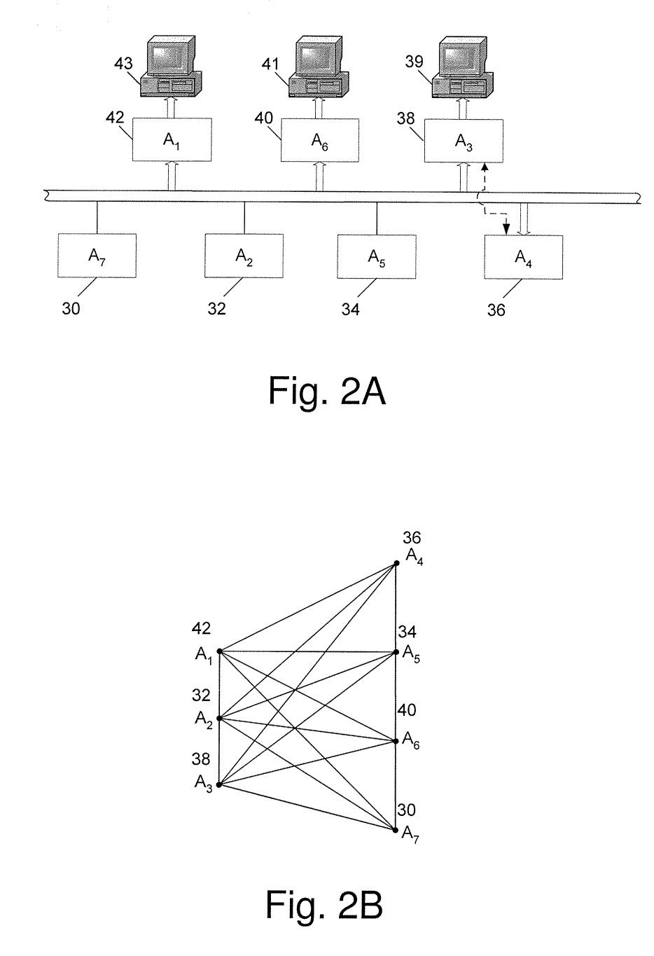

An overview of an organization's network (6) comprising both ordinary and infrastructure agents can be seen in FIG. 2a. Four infrastructure agents (30), (32), (34), and (36), along with three resource agents (38), (40), and (42) are connected to the organization's network. Each resource agent (38), (40), and (42) is connected both to the network (6) and to a specific IT resource, (39), (41), and (43), respectively.

As shown in FIG. 2b, all of the above-mentioned agents, namely, (30), (32), (34), (36), (38), (40), and (42) are connected to each other by a Peer-To-Peer topology through the organization's network. Agents (30), (32), (34), (36), (38), (40), and (42) can therefore all communicate with each other, while transferring data as necessary throughout the organization, thereby optimizing the function of the organization's data network. Since Infrastructure Agents have general functions and enable parallel computing processes to be performed, they allow the organization's resources to be optimized using required processing and memory resources.

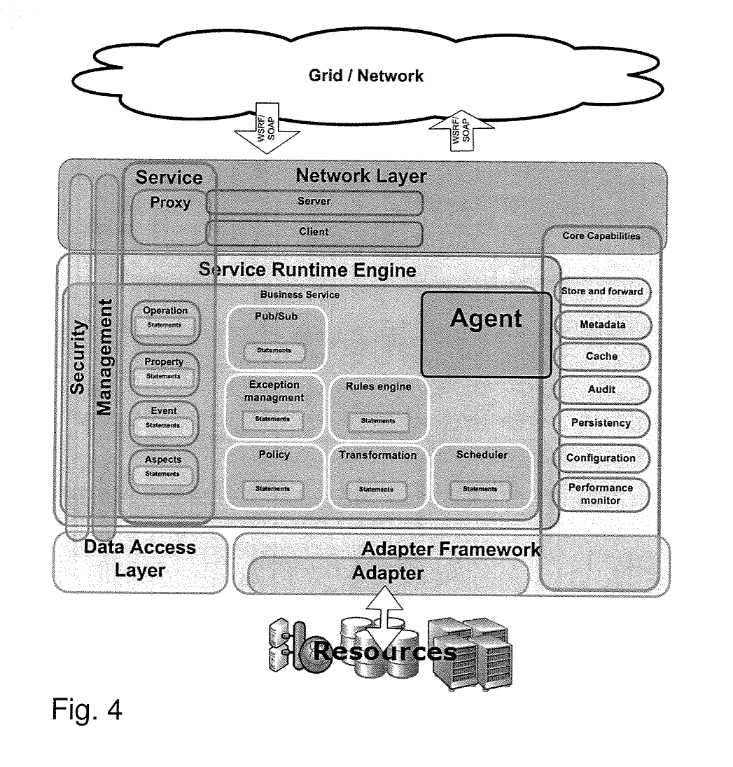

FIG. 4 schematically illustrates the layers of each agent in a conceptual level, according to a preferred embodiment of the invention.

Network Layer—responsible for all connectivity between the agents. The network layer includes the following components:
Protocol Processor—responsible of physical communication between agents, where its implementation may include various communication protocols.
Client Side—responsible to manage all actions related to service requests and events, which are produced by its agent, and are to be sent to other agents in the network. In charge of sending requests, waiting for approval, managing response times, etc.
Server side—responsible to manage all actions related to service requests and events, which are sent to its agent from other agents in the network. In charge of service requests handling, identifying incoming events, etc.
Services—manages the client side and server side components based on the configured business functionality of its agent. In charge of initiating the relevant business logic when a service request is sent to its agent, etc.
   Service Runtime Engine—Responsible of supplying the mechanisms, services and infrastructure, which are used by the agent while executing the business logic it implements. This layer manages the entire Agent's Business Services where each Business Service implements the business logic of the IT resource it represents, through its components:
Business Operation—represents a business function, which is an action or procedure that relates to the consumption of an IT resource, manipulating the resource, or receive information from it.
Business Event—includes all mechanism and infrastructure to identify a business event which occurred in the IT resource (such as inventory deficiencies). It implements a response protocol to the event which is initiated immediately upon the detection of the event in real time.
Business Property—infrastructure to store all required data for the Business Operations and Events functionality.
Business Aspects—manages all infrastructure functionality that does not relate of actual business logic of the IT resource. Includes auditing activities, monitoring, logging, etc.

Each Business Services hosts the following core capabilities, which enables its functionality within the agent:
Store and Forward—mechanism for storing service requests and events before forwarding them on.
Metadata—Each Business Services is metadata-driven, which means it is represented in XML for easy deployment.
Cache—manages all the Agent's caching activities
Audit—manages all auditing activities
Persistency—enables messages persistency through database storing
Configuration—manages all the Agent configurations that modify its operational behavior
Performance Monitoring—enables Quality Of Service through performance statistics managing and analyzing

The Service Runtime Engine hosts Business Services; the illustration includes the Infrastructure Business Services that the network requires, which may be implemented on any specific chosen agent. These Infrastructure Business Services include:
Pub/Sub—responsible for publishing service requests and events to other agents in the network.
Exception Management—responsible to handle all services exceptions
Rules Engine—responsible of handling business rules
Policy—represent an enterprise policy to be enforced
Transformation—responsible for data transformation and schemes manipulations
Scheduler—manages all timed Business Events

Data Access Layer—Responsible of supplying the mechanisms required for accessing IT resources. Manages all the interactions with the IT resources through the Adapter Framework, which contains the specific adapters the Agent utilizes in order to communicate with the IT resources. The Data Access Layer is also utilized to manage all Database operational activities the Agent is performing.

Although embodiments of the invention have been described by way of illustration, it will be understood that the invention may be carried out with many variations, modifications, and adaptations, without departing from its spirit or exceeding the scope of the claims.

1. A system for exposing and extending existing IT capabilities as standard business services, while providing infrastructure services to an organization over a data network, comprising:
a) A group of agents, each of which is a runtime engine for services that represent IT resources of said organization; and
b) a Peer-to-Peer topology layer for connecting between said agents, while exploiting the existing physical data channels of said data network.

2. The system of claim 1, wherein the group of agents consists of configured agents, wherein each agent may run services that represent a certain entity on the organization's network and is responsible for controlling the functionality of the represented IT resource on said organization's network.

3. The system of claim 2, wherein the configuration of the agents is performed through a management console, being a User Interface program that is able to configure the agents and publish the configured metadata to the appropriate agents, for modifying them.

4. The system of claim 1, wherein the group of agents is comprised of configured agents, wherein each agent may run services that are responsible to provide infrastructure services for the whole network.

5. The system of claim 1, wherein the group of agents is comprised of configured agents, wherein each agent may run services that are responsible to offer independent business logic.

6. The system of claim 1, wherein the group of agents comprise:
a) a network layer that comprises the connection of said agent to the organization's network;
b) a logical layer comprises configured business services, and means for monitoring, analysis, security, enterprise policy enforcement, and execution of said business services; and
c) a data access layer that comprises the connection between said agent and the entity which it may represent on said organization's network.

7. The system of claim 1, wherein the agents host business services, which are comprised of Business Events, Business Operations, and Business Properties.

8. The system of claim 1, wherein the agents expose the business services as standard grid services that may be instanced, offer parallel computation, and allow for compensation when a grid service is shutdown.

9. The system of claim 1, wherein the agents are configured by a configuration process to:
a) fit said agents to the organization's communication protocol;
b) define the hosted business services of said agents; and
c) fit said agents to the entity on said organization's network, which their hosted business services may represent.

10. The system of claim 1, wherein the agents may be reconfigured at any time, to change their designated operations.

11. The system of claim 1, wherein one or more agents can connect to external IT resources.

12. The system of claim 1 wherein not all IT resources in the organization are connected to said system.
